(19) United States
(12) Patent Application Publication
(10) Pub. No.: US 2024/0038412 A1
(43) Pub. Date: Feb. 1, 2024

(54) WIRE HANKING AND METHOD OF USING SAME

(71) Applicant: Electrical Components International, Inc., Southfield, MI (US)

(72) Inventor: Henry Chang, Corona, CA (US)

(21) Appl. No.: 18/328,188

(22) Filed: Jun. 2, 2023

Related U.S. Application Data
(60) Provisional application No. 63/392,558, filed on Jul. 27, 2022.

(51) Int. Cl. H01B 7/00; B29C 71/02

(52) U.S. Cl. CPC H01B 7/0045; C08J 7/08; C08J 2327/06

(57) ABSTRACT

A wiring harness includes multiple wires having a portion, a tubular hanking material that extends a length over the portion. The hanking material includes an unshrunk diameter and a shrunk diameter and has a frangible portion that is bounded by first and second rows that are separated by a spacing. The first row is provided by first apertures that are spaced a first distance, and the second row is provided by second apertures that are spaced a second distance. A strip of material in the frangible portion extends along the length. The strip is configured to tear the frangible portion from a remaining portion of the hanking material along the first and second rows when pulled. A first ratio of the unshrunk diameter to the spacing is greater than 1.8, and a second ratio of the unshrunk diameter to one of the first and second distances is greater than 15.

### CROSS-REFERENCE TO RELATED APPLICATION

This application claims priority to U.S. Provisional Application No. 63/392,558 filed Jul. 27, 2022.

### TECHNICAL FIELD

This disclosure relates to a material used to temporarily bundle wires together during an assembly process, after which the material is removed and recycled.

### BACKGROUND

Wiring harness branches are frequently required to be stowed in a manner that facilitates their installation in a particular application. The process of stowing these branches for insertion into a component passage is known colloquially as “hanking” the harness. Hanking is a temporary state; once the harness is in place for installation, the hanking material is removed and disposed of or recycled/re-used.

Common hanking materials include tear tape (tape designed specifically for this purpose that is easily torn, similar to painters tape), silicone bands (typically recycled), and rubber bands (typically thrown away).

A cellophane-like material with a tear strip having a red rip strip (similar to that used for packs of cigarettes or candy) was developed to replace common hanking materials. The application of this hanking material with a removal strip improved the cycle time to remove the material once the harness is in the installed position. But, the features used to promote removal of the tear strip performed in a manner that made it difficult to tear in some applications.

### SUMMARY

In one exemplary embodiment, a wiring harness for assembly into a component, the wiring harness includes multiple wires having a portion, a tubular hanking material that extends a length over the portion, the hanking material includes an unshrunk diameter and a shrunk diameter. The hanking material has a frangible portion that is bounded by first and second rows that are separated by a spacing, the first row is provided by first apertures that are spaced a first distance, and the second row is provided by second apertures that are spaced a second distance, a strip of material in the frangible portion and extends along the length. The strip is configured to tear the frangible portion from a remaining portion of the hanking material along the first and second rows when pulled, and a first ratio of the unshrunk diameter to the spacing is greater than 1.8 and a second ratio of the unshrunk diameter to one of the first and second distances is greater than 15.

In a further embodiment of any of the above, the hanking material is a polyvinyl chloride material.

In a further embodiment of any of the above, the hanking material has a thickness of 40 microns +/−10 microns.

In a further embodiment of any of the above, the hanking material has a diametral shrink ratio of the unshrunk diameter to the shrunk diameter of 50% +/−10% at 130° C. to 200° C.

In a further embodiment of any of the above, the hanking material has a length shrink ratio of less than 10%.

In a further embodiment of any of the above, the shrunk diameter is in a range of 10 mm to 225 mm.

In a further embodiment of any of the above, the first and second apertures are circular in shape.

In a further embodiment of any of the above, the first and second apertures have a diameter of 0.6 mm +/−0.1 mm.

In a further embodiment of any of the above, the spacing is less than 14 mm.

In a further embodiment of any of the above, the shrunk diameter has a circumference that corresponds to a diameter of the portion of wires, and a relationship between the circumference (C) and the spacing (S) is represented by a quadratic equation.

In a further embodiment of any of the above, the quadratic equation is C=−0.121(S)2+4.53(S)−6.65.

In a further embodiment of any of the above, the strip is flush with each of opposing ends of the hanking material in a direction of the length.

In a further embodiment of any of the above, the portion has a mass (M) in grams, and a minimum length required (MLR) for hanking. An overall length of hanking material needed is equal to MLR *(1+(M/498g).

In a further embodiment of any of the above, a component includes the wiring harness, the component includes a passage that receives the hanking material.

In a further embodiment of any of the above, the wiring harness includes multiple branches that are configured to be temporarily held together by the hanking material.

In another exemplary embodiment, a hanking material for a wiring harness includes a tubular hanking material that extends a length that is configured to cover a portion of a wiring harness. The hanking material includes an unshrunk diameter and a shrunk diameter. The hanking material has a frangible portion that is bounded by first and second rows that are separated by a spacing, the first row is provided by first apertures that are spaced a first distance, and the second row is provided by second apertures that are spaced a second distance, a strip of material in the frangible portion and extends along the length. The strip is configured to tear the frangible portion from a remaining portion of the hanking material along the first and second rows when pulled, and the shrunk diameter has a circumference that corresponds to a diameter of the portion, and a relationship between the circumference (C) and the spacing (S) is represented by a quadratic equation C=−0.121(S)2+4.53(S)−6.65.

In a further embodiment of any of the above, the hanking material is a polyvinyl chloride material, with a thickness of 40 microns +/−10 microns, and a diametral shrink ratio of the unshrunk diameter to the shrunk diameter of 50% +/−10% at 130° C. to 200° C.

In a further embodiment of any of the above, the first and second apertures are circular in shape and have a diameter of 0.6 mm +/−0.1 mm.

In a further embodiment of any of the above, a first ratio of the unshrunk diameter to the spacing is greater than 1.8 and a second ratio of the unshrunk diameter to one of the first and second distances is greater than 15.

In another exemplary embodiment, a wiring harness for assembly into a component, the wiring harness includes multiple wires that have a portion, a tubular hanking material that extends a length over the portion, the hanking material includes an unshrunk diameter and a shrunk diameter. The hanking material has a frangible portion that is bounded by first and second rows that are separated by a spacing, the first row is provided by first apertures that are spaced a first distance, and the second row is provided by second apertures that are spaced a second distance, a strip of material in the frangible portion and extends along the length. The strip is configured to tear the frangible portion from a remaining portion of the hanking material along the first and second rows when pulled, and the shrunk diameter has a circumference that corresponds to a diameter of the portion of wires, and a relationship between the circumference (C) and the spacing (S) is represented by a quadratic equation C=−0.121(S)2+4.53(S)−6.65.

### BRIEF DESCRIPTION OF THE DRAWINGS

The disclosure can be further understood by reference to the following detailed description when considered in connection with the accompanying drawings wherein:

FIG. 1 is a schematic view of a wiring harness.

FIG. 2 is a schematic view of a component with a passage in which the wiring harness is inserted after hanking.

FIG. 3A is a perspective view of the hanking material in an unshrunk state.

FIG. 3B is a perspective view of the hanking material in a shrunk state.

FIG. 4 is a plan view illustrating the hanking material in the shrunk state with features providing a frangible portion or tear strip.

FIG. 5 is a partial cross-sectional view of a hanked wiring harness taken along line 5-5 in FIG. 2.

FIG. 6 is a graph depicting the relationship between the shrunk hanking material or harness circumference versus a width of the frangible portion.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

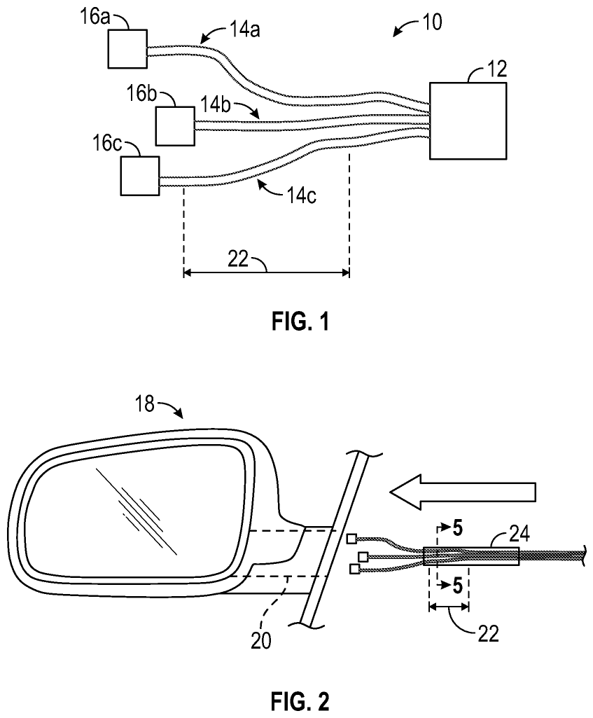

A wiring harness 10 is schematically shown in FIG. 1. A typical wiring harness 10 includes one or more connectors 12 at one end that extends to provide multiple branches of wires or pigtails 14a-14c (collectively, “14”) that may terminate in other connectors 16a-16c. It should be understood that the illustrated wiring harness 10 is exemplary only and may come in any number of configurations, and with or without connectors.

Referring to FIGS. 1 and 2, in some applications the wiring harness 10 is inserted into a passage 20 or tight space for some assembly operations. It may be difficult and time consuming to insert a complex wiring harness having many pigtails into a small passage. To that end, a length of a portion of the harness 10 is “hanked” to temporarily group the branches 14 compactly to one another for the purpose of assembly. FIG. 2 illustrates one example component 18, a mirror, in which the length 22 has a hanking material 24 circumscribing the branches 14 for insertion into the passage 20.

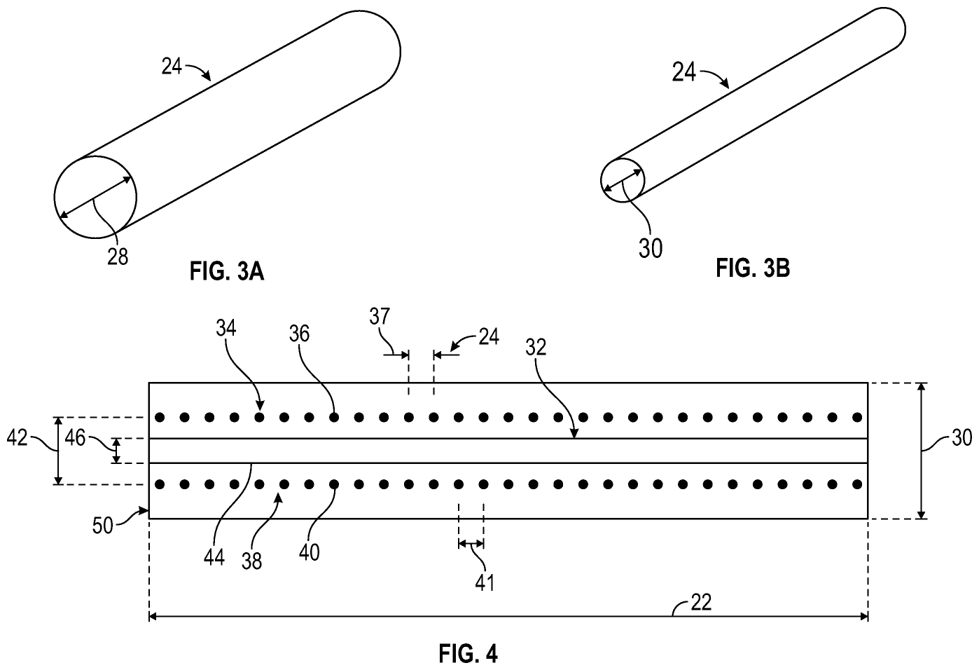

FIGS. 3A and 3B respectively illustrate the tubular hanking material 24 having an unshrunk diameter 28 and a shrunk diameter 30. In one example, the hanking material 24 is provided by a polyvinyl chloride having a diametral shrink ratio of unshrunk diameter to shrunk diameter of 50% +/−10% at 130° C. to 200° C. The shrink ratio in a lengthwise direction of the hanking material 24 is relatively small, less than 10%. During an assembly operation, the unshrunk hanking material is slid over the branches of wires, and heat is applied to shrink the hanking material and secure the branches in a compact arrangement for later handling and assembly.

The shrunk hanking material is shown in more detail in FIG. 4. A frangible portion or tear strip 32 is provided along the length 22 of the hanking material 24. In the example, the frangible portion 32 is defined by a first row 34 of first apertures 36 separated a first distance 37, and a second row 38 of second apertures 40 spaced a second distance 41. In one example, the first and second distances 37, 41 are the same. That is, the first and second apertures 37, 41 have the same spaced relationship in each of the first and second rows 34, 38. While the first and second apertures 36, 40 can be provided by any suitable shape and vary from row to row, in the example, all the apertures are circular and have a diameter of 0.6 mm +/−0.1 mm.

The first and second rows 34, 38 are separated by a spacing 42 that defines the width of the tear strip 32. In one example, the spacing is less than 14 mm, but may vary according the quadratic equation discussed below.

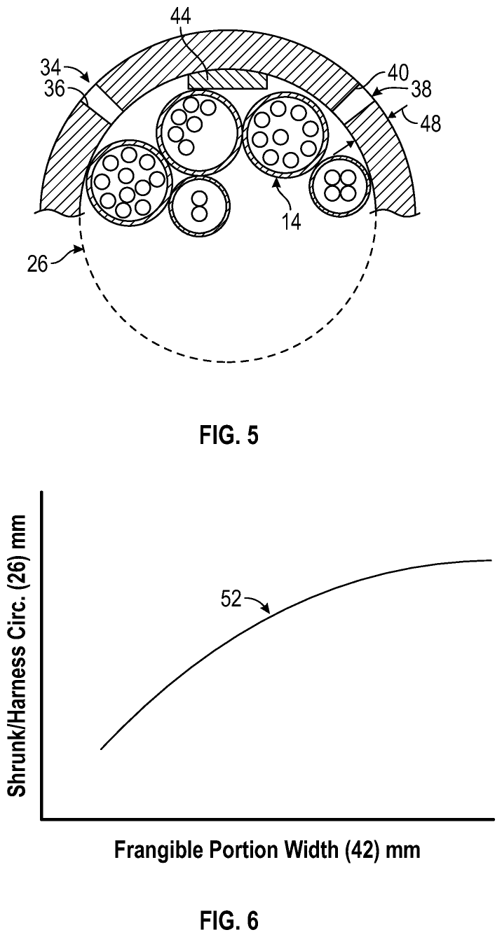

The hanking material 24 is clear or translucent having a thickness 48 of 40 μm +/−10 μm, as best shown in FIG. 5. Within the frangible portion 32 and beneath the outer surface of the hanking material 24, a rip strip 44 is provided of a different color, such as red, which is easily identifiable by the assembly operator. The rip strip 44 is cut flush with the end 50 of the hanking material 24, as shown in FIG. 4. The rip strip 44 has a width 46 sufficient to be easily visible to the assembly operator as well as provide sufficient strength to tear the frangible portion 32 from the remaining portion of the hanking material 24 during component assembly.

It is difficult to design a hanking material that behaves consistently and as desired for different wiring harness applications, which may vary in diameter from 10 mm to 225 mm. Accordingly, hanking material has been re-engineered as disclosed so the tear strip 32 may be removed both easily and yet stay together while holding the wiring harness together during assembly, even for heavy wiring harnesses.

Referring to FIG. 6, there is a relationship 52 between the shrunk hanking material circumference 26, which also corresponds to the portion of the hanked wiring harness portion, and the width of tear strip 32 or the spacing 42. The relationship may be expressed as follows:

C=−0.121(S)2+4.53(S)−6.65,
where C is the circumference 26, and S is the spacing 42.

There also is a useful relationship to the mass of the portion of the wiring harness to be hanked and the minimum length required for hanking, which is representative of how difficult it is to hold the wiring harness together without prematurely breaking the tear strip during handling. Generally, the heavier the wiring harness, the longer the hanking material should be even beyond what appears to be needed. This relationship may be expressed as:

overall length of hanking material needed=MLR*(1+(M/498 g),
where M is the mass of the portion to be hanked in grams, and
MLR is the minimum length required for hanking.

Additional relationships may also be useful. For example, a first ratio of the unshrunk diameter to the spacing is greater than 1.8 (e.g., in a range of 1.8 to 2.2) and a second ratio of the unshrunk diameter to one of the first and second distances is greater than 15 (e.g., in a range of 15 to 28).

The hanking material according to this disclosure performs consistently for a variety of applications. The hanking material provides sufficient “hold” of the wire bundle during assembly, but is not too strong such that it can be easily removed by the assembler.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A wiring harness for assembly into a component, the wiring harness comprising:
multiple wires having a portion;
a tubular hanking material extending a length over the portion, the hanking material including an unshrunk diameter and a shrunk diameter, the hanking material having:
a frangible portion bounded by first and second rows separated by a spacing, the first row provided by first apertures spaced a first distance, and the second row provided by second apertures spaced a second distance,
a strip of material in the frangible portion and extending along the length, the strip configured to tear the frangible portion from a remaining portion of the hanking material along the first and second rows when pulled, and
wherein a first ratio of the unshrunk diameter to the spacing is greater than 1.8 and a second ratio of the unshrunk diameter to one of the first and second distances is greater than 15.

2. The wiring harness of claim 1, wherein the hanking material is a polyvinyl chloride material.

3. The wiring harness of claim 2, wherein the hanking material has a thickness of 40 microns +/−10 microns.

4. The wiring harness of claim 1, wherein the hanking material has a diametral shrink ratio of the unshrunk diameter to the shrunk diameter of 50% +/−10% at 130° C. to 200° C.

5. The wiring harness of claim 4, wherein the hanking material has a length shrink ratio of less than 10%.

6. The wiring harness of claim 4, wherein the shrunk diameter is in a range of 10 mm to 225 mm.

7. The wiring harness of claim 1, wherein the first and second apertures are circular in shape.

8. The wiring harness of claim 7, wherein the first and second apertures have a diameter of 0.6 mm +/−0.1 mm.

9. The wiring harness of claim 1, wherein the spacing is less than 14 mm.

10. The wiring harness of claim 1, wherein the shrunk diameter has a circumference that corresponds to a diameter of the portion of wires, and a relationship between the circumference (C) and the spacing (S) is represented by a quadratic equation.

11. The wiring harness of claim 10, wherein the quadratic equation is C=−0.121 (S)²+4.53(S)−6.65.

12. The wiring harness of claim 1, wherein the strip is flush with each of opposing ends of the hanking material in a direction of the length.

13. The wiring harness of claim 1, wherein the portion has a mass (M) in grams, and a minimum length required (MLR) for hanking, wherein an overall length of hanking material needed is equal to MLR *(1+(M/498 g).

14. A component including the wiring harness of claim 1, wherein the component includes a passage receiving the hanking material.

15. The component of claim 14, wherein the wiring harness includes multiple branches that are configured to be temporarily held together by the hanking material.

16. A hanking material for a wiring harness, comprising:
a tubular hanking material extending a length that is configured to cover a portion of a wiring harness, the hanking material including an unshrunk diameter and a shrunk diameter, the hanking material having:
a frangible portion bounded by first and second rows separated by a spacing, the first row provided by first apertures spaced a first distance, and the second row provided by second apertures spaced a second distance,
a strip of material in the frangible portion and extending along the length, the strip configured to tear the frangible portion from a remaining portion of the hanking material along the first and second rows when pulled, and
wherein the shrunk diameter has a circumference that corresponds to a diameter of the portion, and a relationship between the circumference (C) and the spacing (S) is represented by a quadratic equation C=−0.121(S)2+4.53(S)−6.65.

17. The hanking material of claim 16, wherein the hanking material is a polyvinyl chloride material, with a thickness of 40 microns +/−10 microns, and a diametral shrink ratio of the unshrunk diameter to the shrunk diameter of 50% +/−10% at 130° C. to 200° C.

18. The hanking material of claim 17, wherein the first and second apertures are circular in shape and have a diameter of 0.6 mm +/−0.1 mm.

19. The hanking material of claim 16, wherein a first ratio of the unshrunk diameter to the spacing is greater than 1.8 and a second ratio of the unshrunk diameter to one of the first and second distances is greater than 15.

20. A wiring harness for assembly into a component, the wiring harness comprising:
multiple wires having a portion;
a tubular hanking material extending a length over the portion, the hanking material including an unshrunk diameter and a shrunk diameter, the hanking material having:
a frangible portion bounded by first and second rows separated by a spacing, the first row provided by first apertures spaced a first distance, and the second row provided by second apertures spaced a second distance,
a strip of material in the frangible portion and extending along the length, the strip configured to tear the frangible portion from a remaining portion of the hanking material along the first and second rows when pulled, and
wherein the shrunk diameter has a circumference that corresponds to a diameter of the portion of wires, and a relationship between the circumference (C) and the spacing (S) is represented by a quadratic equation C=−0.121(S)2+4.53(S)−6.65.
